(19) United States
(12) Patent Application Publication
(10) Pub. No.: US 2014/0203725 A1
(43) Pub. Date: Jul. 24, 2014

(54) POWER CIRCUIT OF A VACUUM FLUORESCENT DISPLAY HAVING NEITHER TRANSFORMER NOR ELECTROMAGNETIC INTERFERENCE

(71) Applicant: CHYNG HONG ELECTRONIC CO., Taichung (TW)

(72) Inventor: Mu-Chun Lin, Taichung (TW)

(73) Assignee: CHYNG HONG ELECTRONIC CO., Taichung (TW)

(21) Appl. No.: 13/744,732

(22) Filed: Jan. 18, 2013

(51) Int. Cl. H05B 41/16

(52) U.S. Cl. CPC H05B 41/16
USPC 315/291

(57) ABSTRACT

A power circuit of a vacuum fluorescent display having neither transformer nor electromagnetic interference comprises a DC power supplier that provides a high-voltage power supply and a low-voltage power supply. The high-voltage power supply is connected to an amplifying and doubling circuit that is further connected to a positive pole and a grid of the vacuum florescent display. The low-voltage power supply is connected to a linear amplifying circuit that outputs a sinusoidal wave and connects to a filament of the vacuum fluorescent display, thereby motivating the vacuum fluorescent display of the present invention. Consequently, by means of the sinusoidal wave, the electromagnetic interference is prevented, and the present invention is able to lower the costs of materials, save spaces, and operate without the restriction of the mains electricity.

### FIELD OF THE INVENTION

The present invention relates to a power circuit of a vacuum fluorescent display having neither transformer nor electromagnetic interference.

### DESCRIPTION OF THE RELATED ART

Referring to FIG. 1, a conventional vacuum fluorescent display (VFD) cooperates with mains electricity, so that an AC power 13 is able to trigger a filament 10 and the filament 10 releases thermal electrons. Further, the thermal electrons are speeded up by a bias voltage driving a grid 11, so that the thermal electrons collide with a fluorescent body of a positive pole 12. Accordingly, the fluorescent body is triggered for providing light. Herein, the fluorescent body has high illumination and contrast; namely, the fluorescent body radiates by itself.

In fact, the conventional vacuum fluorescent display is driven by the AC power. Moreover, the AC power is provided by the mains electricity and limited by the same. Thus, in order to conquer afore limitation, there is a power circuit of a vacuum fluorescent display cooperating with a DC bias. Such power circuit generates a square wave by means of a switching power supply cooperating with a transformer so as to trigger the filament. Accordingly, the vacuum fluorescent display is launched.

However, this type of power circuit of the vacuum fluorescent display is easily interfered by electro-magnetic energy since the power circuit is limited by the square wave generated by the switching power supply and the transformer. Wherein, the interference adversely influences the display effect of the vacuum fluorescent display. Fortunately, the Futaba and the Trinamic cooperatively developed a power IC of a sinusoidal wave vacuum fluorescent display in order to conquer problems existing in the conventional ones. A solution TMC 363 is provided as shown in FIG. 2. A switch mode pulse width modulation (SWPWM) 21, such as Boost, provides the needs of a positive pole 23 and a grid 24 and cooperates with a sinusoidal pulse width modulation (SinPWM) 20. Accordingly, the sinusoidal wave of 50 kHz to 80 kHz is generated for driving a filament 22. However, the electromagnetic interference is lessened by the sinusoidal pulse in the vacuum fluorescent display, but the needs of the positive pole and the grid are provided by a boost type switch mode pulse width modulation. Namely, the positive pole and the grid belong to the pulse width modulation, and moreover, the sinusoidal pulse width modulation that drives the filament also belongs to the pulse width modulation. Herein, the vacuum fluorescent display is driven by the pulse width modulation, so the electromagnetic interference still exists.

In order to further lessen the electromagnetic interference on the vacuum fluorescent display, the National Semiconductor provides another solution LM9022 as shown in FIG. 3. A block diagram of the LM9022 type of a power circuit of a vacuum fluorescent display developed by the National Semiconductor is provided. An amplifying circuit 31 is utilized to output a square wave for driving a filament 32 of the power circuit of the vacuum fluorescent display.

Continuing with FIG. 3, such power circuit of the vacuum fluorescent display does not utilize the boost type switch mode pulse width modulation but employs the amplifying circuit 31 to drive the filament 32 of the power circuit of the vacuum fluorescent display. Herein, the vacuum fluorescent display drives the filament 32 via the square wave. As shown in FIG. 4 of an oscillogram of the vacuum fluorescent display, the vacuum fluorescent display drives the filament of the power circuit of the vacuum fluorescent display via the square wave, so the electromagnetic interference on the vacuum fluorescent display can not be prevented thoroughly. Further, an input voltage of a power supply end 30 of the vacuum fluorescent display merely contains the voltage of 5 volts. Even if the voltages transmitted to the grid 33 and the positive pole 34 of the vacuum fluorescent display are augmented, the augmented voltage merely conforms to the low voltage that the vacuum fluorescent display with a small monitor needs. Herein, if the voltage has to be augmented to a high voltage of 56 volts for the grid and 96 volts for the positive pole in the vacuum fluorescent display with a large monitor, the needed augmenting rate is difficult to be attained. Therefore, the voltage is unsuited for the vacuum fluorescent display with the large monitor.

Preferably, the inventor of the present invention endeavors to conquer shortcomings exiting in the conventional vacuum fluorescent display by means of his experienced skills in the electronic apparatus and other correlated researches of parts as well as his familiarity with the marketing.

### SUMMARY OF THE INVENTION

The object of the present invention is to provide a power circuit of a vacuum fluorescent display having neither transformer nor electromagnetic interference. While a linear amplifying circuit outputs a sinusoidal wave, the present invention is prevented from electromagnetic interference. Favorably, a DC power and an amplifying and doubling circuit help lessen the costs of materials and save spaces. The present invention is not limited by the mains electricity but able to provide a voltage conforming to the vacuum fluorescent display with a large monitor.

The power circuit of the vacuum fluorescent display having neither transformer nor electromagnetic interference in accordance with the present invention comprises a DC power supplier being able to provide a high-voltage power supply and a low-voltage power supply, respectively. The high-voltage power supply is connected to an amplifying and doubling circuit that is connected to a positive pole and a grid of the vacuum fluorescent display, respectively. The amplifying and doubling circuit is able to double the DC voltage output by the high-voltage power supply and respectively transmit the doubled DC voltage to the positive pole and the grid. The low-voltage power supply is connected to a linear amplifying circuit that is connected to a filament of the vacuum fluorescent display. The linear amplifying circuit is able to output a sinusoidal wave and transmit the sinusoidal wave to the filament so as to trigger the filament.

The power circuit of the vacuum fluorescent display having neither transformer nor electromagnetic interference of the present invention utilizes the DC power supply so as to prevent limitation from the mains electricity. The amplifying and doubling circuit is able to augment the DC voltage so as to conform to the voltage needed in the vacuum fluorescent display with a large monitor. Thus, the power circuit of the vacuum fluorescent display of the present invention does not need the transformer, which lessens the costs of materials and saves spaces. When the linear amplifying circuit is utilized for outputting the sinusoidal wave, the present invention is obstructed from electromagnetic interference on the power circuit of the vacuum fluorescent display.

### BRIEF DESCRIPTION OF THE DRAWINGS

FIG. 1 is a block diagram showing a conventional power circuit of a vacuum fluorescent display;

FIG. 2 is a block diagram showing a conventional TMC 363 type power circuit of a vacuum fluorescent display;

FIG. 3 is a block diagram showing a conventional LM9022 type power circuit of a vacuum fluorescent display;

FIG. 4 is an oscillogram showing the conventional vacuum fluorescent display;

FIG. 5 is a block diagram showing a DC power supply of the present invention;

FIG. 6 is a block diagram showing a preferred embodiment of the present invention;

FIG. 7 is a circuit diagram showing a circuit that is amplified and doubled;

FIG. 8 is a circuit diagram showing a circuit that is linearly amplified; and

FIG. 9 is an oscillogram of the present invention.

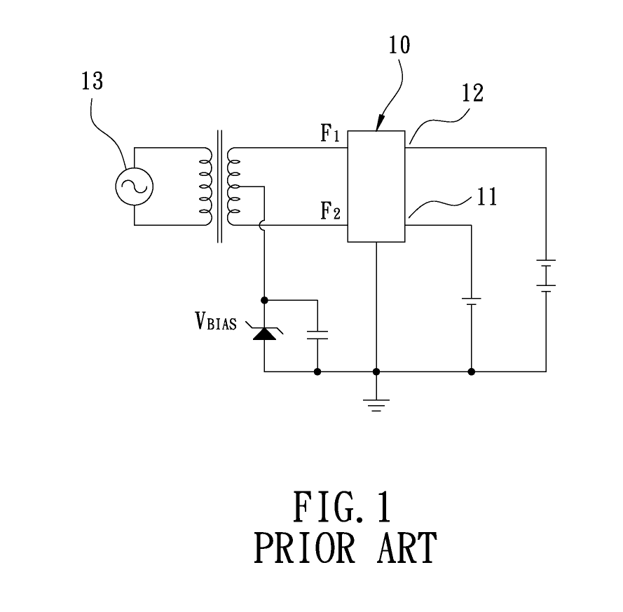

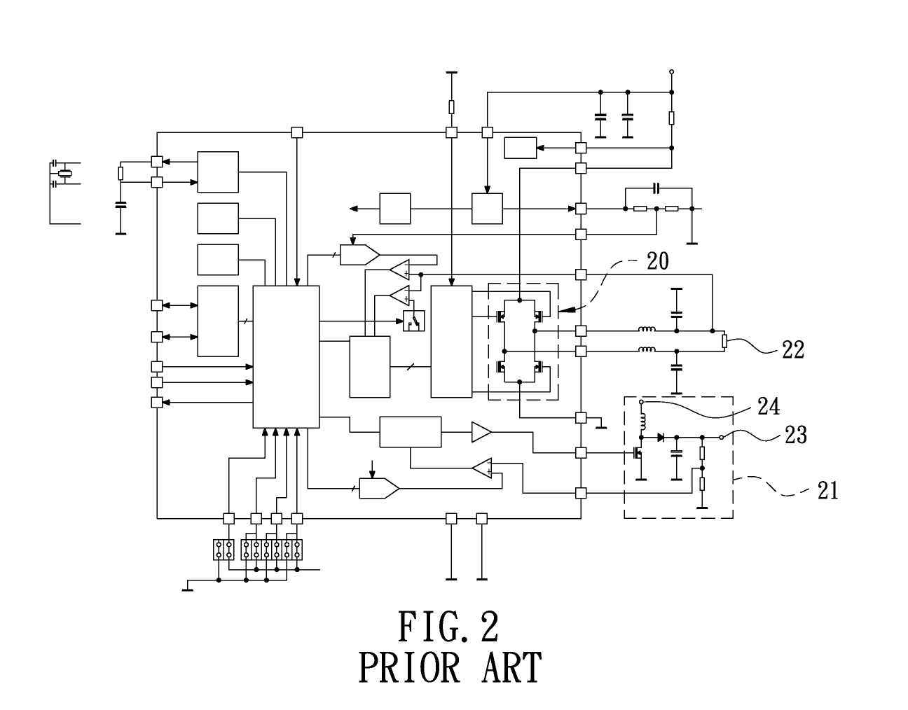

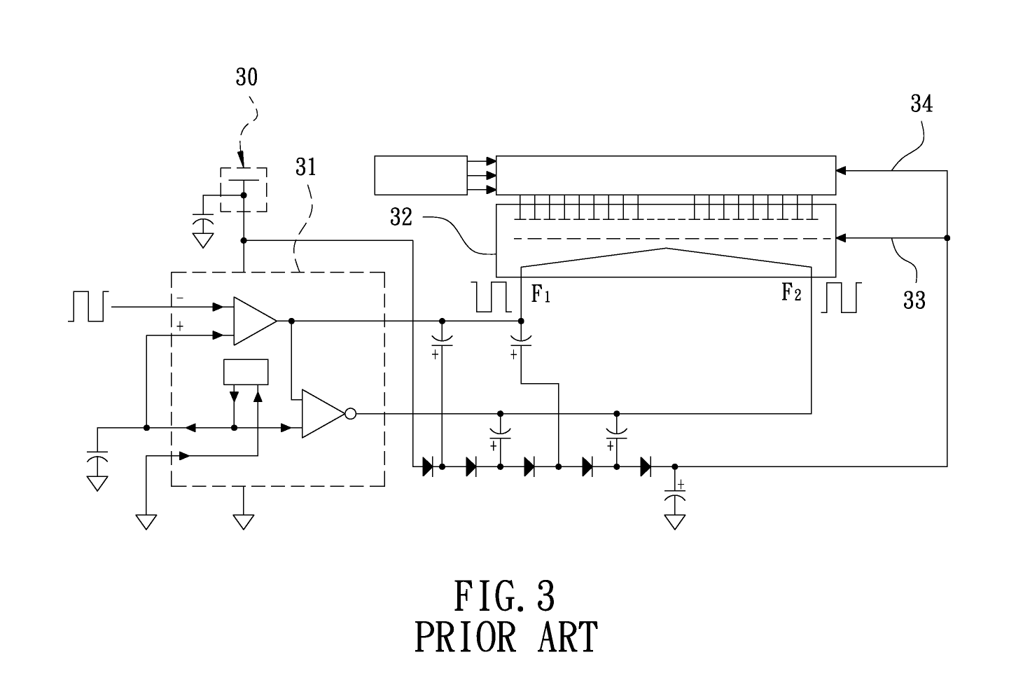

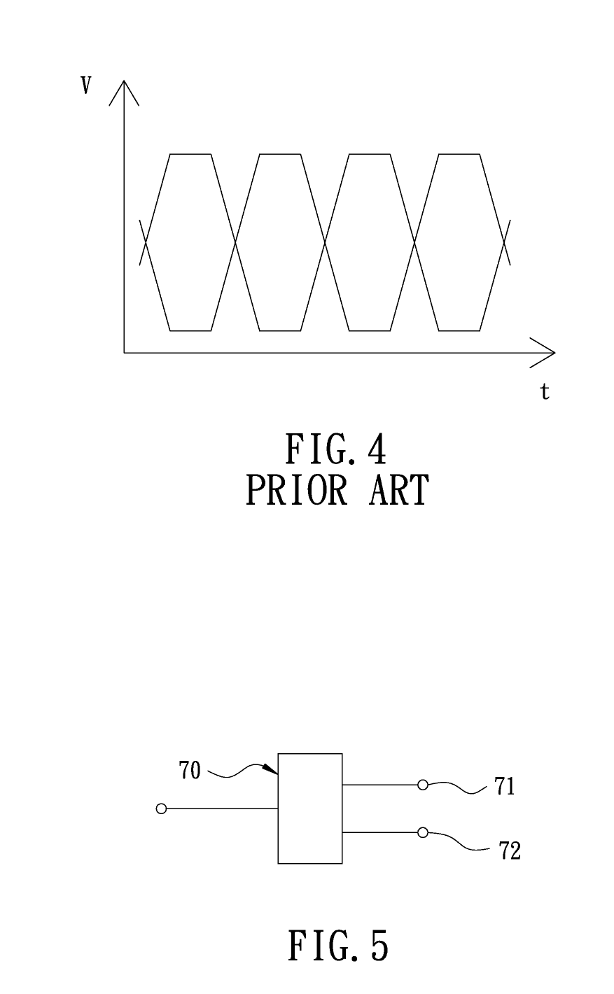

### DETAILED DESCRIPTION OF THE PREFERRED EMBODIMENTS

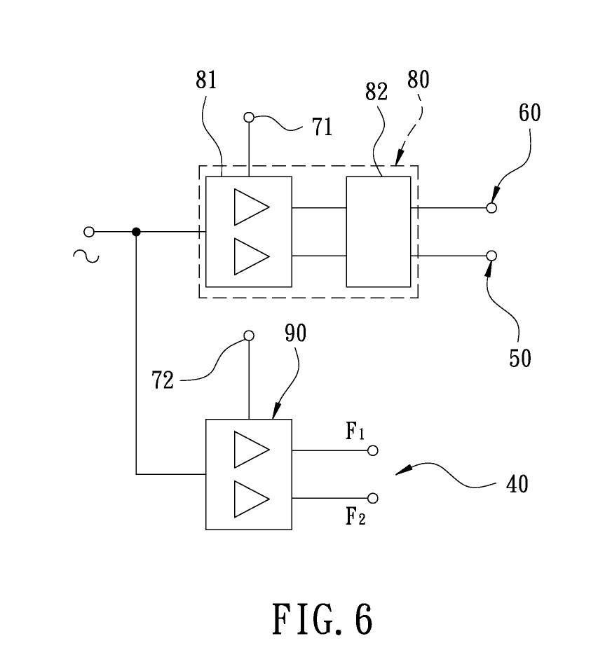

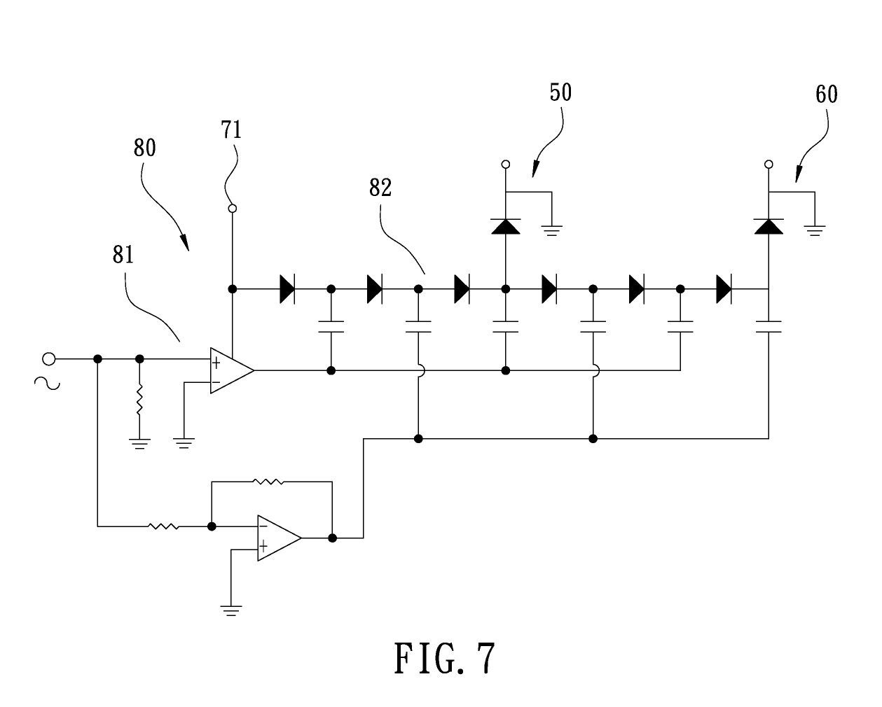

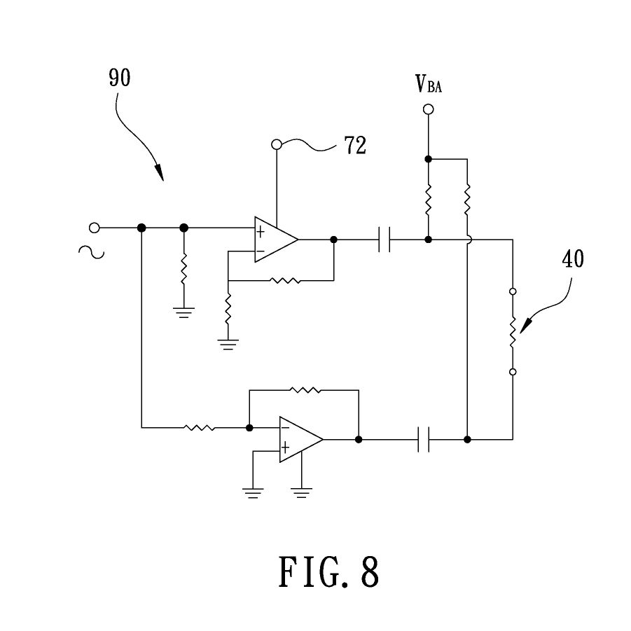

FIG. 6 shows a block diagram of the present invention. FIGS. 7 and 8 show exploded linear circuit diagrams of an amplifying and doubling circuit of the present invention. A power circuit of a vacuum fluorescent display having neither transformer nor electromagnetic interference is disclosed. The vacuum fluorescent display having neither transformer nor electromagnetic interference comprises:

a filament 40 that is driven by a sinusoidal signal for releasing thermal electrons to motivate the vacuum fluorescent display of the present invention;

a grid 50 that is driven by a DC voltage signal for speeding up the thermal electrons released by the filament 40 to control the spread of the thermal electrons; and

a positive pole 60 that is driven by the DC voltage signal for receiving the thermal electrons that are speeded up by the grid 50 to motivate a fluorescent body of the positive pole 60, so that the positive pole 60 is able to radiate by itself.

The power circuit of the vacuum fluorescent display having neither transformer nor electromagnetic interference of the present invention comprises:

A DC power supplier 70 outputs a DC voltage. Accompanying with FIG. 5, the DC power supplier 70 is able to output a high-voltage power supply 71 and a low-voltage power supply 72, respectively. The DC power supplier 70 is able to provide a high-voltage direct current via the high-voltage power supply 71 and a low-voltage direct current via the low-voltage power supply 72. In this embodiment, the high-voltage power supply 71 provides a DC voltage of 24 volts, and the low-voltage power supply 72 provides a DC voltage of 10 volts. However, this embodiment does not limit the applying scope of the present invention.

An amplifying and doubling circuit 80 includes an amplifying circuit 81 whose input end is a sinusoidal wave signal. An output end of the amplifying circuit 81 is connected to a doubling circuit 82. The amplifying and doubling circuit 80 is connected to the high-voltage power supply 71. The high-voltage power supply 71 provides the amplifying and doubling circuit 80 with a bias voltage. The output end of the amplifying and doubling circuit 80 is further connected to the positive pole 60 and the grid 50 for augmenting the sinusoidal wave signal input to the amplifying and doubling circuit 80 and the DC voltage output by the high-voltage power supply 71. Thence, the augmented sinusoidal signal and the DC voltage are respectively transmitted to the positive pole 60 and the grid 50. Thereby, the positive pole 60 and the grid 50 are provided with the needed DC voltages. Wherein, in this embodiment, the amplifying and doubling circuit 80 augments the DC voltage of 24 volts output by the high-voltage power supply 71 to 96 volts for the positive pole 60. Further, the amplifying and doubling circuit 80 concurrently augments the 24 volts output by the high-voltage power supply 71 to 56 volts for the grid 50.

A linear amplifying circuit 90 has an input end to be served as a sinusoidal wave signal and an output end connected to the filament 40. The linear amplifying circuit 90 is connected to the low-voltage power supply 72. The low-voltage power supply 72 provides the linear amplifying circuit 90 with a bias voltage. The linear amplifying circuit 90 is able to linearly amplify the sinusoidal wave input thereto so as to out a sinusoidal wave with the frequency scope from 20 kHz to 80 kHz. Afterward, the sinusoidal wave is transmitted to the filament 40 for driving the filament 40. In this embodiment, the linear amplifying circuit 90 outputs the sinusoidal wave of 30 kHz for driving the filament 40.

Referring to FIGS. 6 and 7, in order to motivate the vacuum fluorescent display, the high-voltage power supply 71 provides the DC voltage of 24 volts, and the DC voltage is augmented by the amplifying and doubling circuit 80. Accordingly, the augmented voltage provides the vacuum fluorescent display with a sufficient voltage. The DC voltage that is augmented to 96 volts is transmitted to the positive pole 60 for providing the positive pole 60 with a sufficient DC voltage. Concurrently, the DC voltage that is augmented to 56 volts is transmitted to the grid 50, so that the grid 50 is provided with a sufficient DC voltage for controlling the spread of the thermal electrons. Preferably, the present invention utilizes the amplifying and doubling circuit 80 to augment the voltage. Namely, no transformer is needed but the voltage is still augmented. Accordingly, the occupied space is decreased, and the manufacturing cost is also lessened.

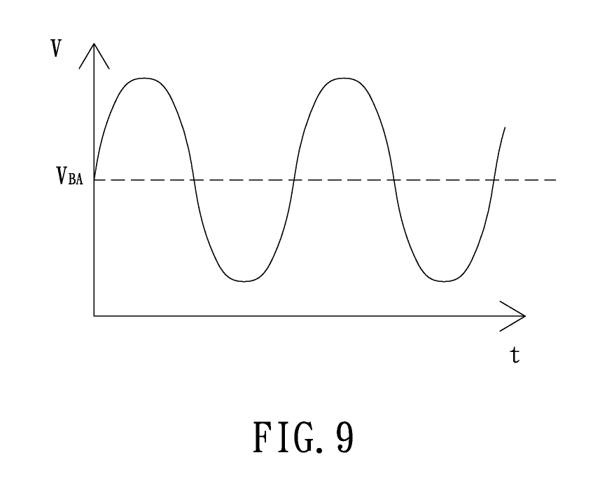

Referring to FIG. 8, the linear amplifying circuit 90 is connected to the filament 40. While the low-voltage power supply 72 provides the linear amplifying circuit 90 with a DC voltage of 10 volts, the linear amplifying circuit thence outputs a sinusoidal wave of 5 volts root mean square and 30 kHz. Referring to FIG. 9, an oscillogram of the present invention is shown. A DC bias voltage V_{BA} of 13 volts is added for being transmitted to the sinusoidal wave of 5 volts root meant square output by the linear amplifying circuit. Thence, the sinusoidal wave is further transmitted to the filament 40 so as to motivate the filament 40. Favorably, the vacuum fluorescent display of the present invention is able to radiate by itself. Further, the present invention is prevented from the electromagnetic interference caused by the switching power supply and the square wave that trigger the filament.

Preferably, while the present invention utilizes the DC power supplier 70 to provide the DC voltage, the power circuit of the vacuum fluorescent display having neither transformer nor electromagnetic interference does not have to be limited by the mains electricity.

I claim:

1. A power circuit of a vacuum fluorescent display having neither transformer nor electromagnetic interference; wherein, said vacuum fluorescent display including a positive pole, a grid, and a filament; said power circuit of said vacuum fluorescent display having neither transformer nor electromagnetic interference including:
a DC power supplier that outputs a DC voltage; said DC power supplier being able to output a high-voltage power supply and a low-voltage power supply, respectively;
an amplifying and doubling circuit having one end thereof connected to said DC power supplier and the other end thereof connected to said positive pole and said grid of said vacuum fluorescent display, respectively; said amplifying and doubling circuit being able to double said DC voltage output by said DC power supplier and respectively transmit said doubled DC voltage to said positive pole and said grid; and
a linear amplifying circuit having one end thereof connected to said DC power supplier and the other end thereof connected to said filament of said vacuum fluorescent display; said linear amplifying circuit being able to output a sinusoidal wave and transmit said sinusoidal wave to said filament so as to trigger said filament.

2. The power circuit as claimed in claim 1, wherein, said amplifying and doubling circuit comprises an amplifying circuit that connects to a doubling circuit.

3. The power circuit as claimed in claim 1, wherein, said high-voltage power supply of said DC power supplier outputs a DC voltage of 24 volts.

4. The power circuit as claimed in claim 1, wherein, said low-voltage power supply of said DC power supplier outputs a DC voltage of 10 volts.

5. The power circuit as claimed in claim 1, wherein, said amplifying and doubling circuit augments said DC voltage output from said DC power supplier to 56 volts.

6. The power circuit as claimed in claim 1, wherein, said amplifying and doubling circuit augments said DC voltage output from said DC power supplier to 96 volts.
